(19) United States
(12) Patent Application Publication
(10) Pub. No.: US 2026/0203356 A1
(43) Pub. Date: Jul. 16, 2026

(54) DOCUMENT MANAGEMENT METHOD, DOCUMENT MANAGEMENT SYSTEM, AND DOCUMENT MANAGEMENT PROGRAM

(71) Applicant: LegalOn Technologies, Inc., Tokyo (JP)

(72) Inventors: Chie SUZUKI, Tokyo (JP); Taizo YAMADA, Tokyo (JP); Akihiko MATSUBA, Tokyo (JP); Takakazu YANAKA, Tokyo (JP)

(73) Assignee: LegalOn Technologies, Inc., Tokyo (JP)

(21) Appl. No.: 19/551,052

(22) Filed: Feb. 26, 2026

Related U.S. Application Data
(63) Continuation of application No. PCT/JP2024/030365, filed on Aug. 27, 2024.

(30) Foreign Application Priority Data
Aug. 31, 2023 (JP) 2023-140791

(51) Int. Cl. G06F 16/93

(52) U.S. Cl. CPC G06F 16/93

(57) ABSTRACT

An embodiment of a document management method includes: acquiring a plurality of pieces of target document information belonging to a series of correction processes; and storing the plurality of pieces of target document information in a storage unit in association with order information indicating an order of the series of correction processes.

### CROSS-REFERENCE TO RELATED APPLICATION

This application is a continuation of International Application No. PCT/JP2024/030365, filed on Aug. 27, 2024, which designates the United States, and which claims the benefit of priority from Japanese Patent Application No. 2023-140791, filed on Aug. 31, 2023. The entire contents of each of the above-identified applications are incorporated herein by reference.

### BACKGROUND

### Technical Field

The present disclosure relates to a document management method, a document management system, and a document management program.

### Related Art

Conventionally, a technique for managing a plurality of pieces of document information in association with each other is known.

For example, an information processing apparatus described in Japanese Laid-Open Patent Publication No. 2020-184271 transmits, to a target person, acquisition information that is information enabling acquisition of a stored document that is a document stored in a specific area, and transmits, to the target person, storage information that is information enabling storage of a created document that is a document created by the target person in the specific area on the basis of the stored document acquired using the acquisition information. In addition, the apparatus associates the created document and the stored document stored in the specific area using the storage information, and displays information regarding the created document and information regarding the stored document in association with each other.

### SUMMARY

A document management method according to the embodiment of the present disclosure is a document management method executed by a processor, including: collectively acquiring a plurality of pieces of target document information belonging to a series of correction processes; and storing the plurality of pieces of target document information in a predetermined storage unit in association with order information indicating an order of the series of correction processes.

In addition, a document management method according to the embodiment of the present disclosure is a document management method executed by a processor, including: collectively acquiring at least one piece of target document information and related material information regarding material related to the at least one piece of target document information; and storing the at least one piece of target document information and the related material information in a predetermined storage unit in association with each other.

In addition, a document management method according to the embodiment of the present disclosure is a document management method executed by a processor, including: acquiring target document information including correction history information regarding a history of correction; extracting at least one piece of candidate document information belonging to the same series of correction processes as the target document information from among a plurality of pieces of document information stored in a predetermined storage unit, on the basis of at least one piece of old edition document information corresponding to a previous version of the target document information, the old edition document information being generated on the basis of the correction history information and corresponding to a correction process corresponding to the history of correction; and storing the target document information, the at least one piece of candidate document information, and order information indicating an order of the correction processes in a predetermined storage unit in association with one another.

### BRIEF DESCRIPTION OF DRAWINGS

FIG. 1 is a diagram illustrating a configuration of a document management system according to an embodiment of the present disclosure;

FIG. 2 is a diagram illustrating an example of correction history information of the present embodiment;

FIG. 3 is a diagram illustrating an example of first display information displayed on a user terminal;

FIG. 4 is a diagram illustrating an example of target document information stored in a storage unit;

FIG. 5 is a flowchart illustrating an example of processing in the document management system;

FIG. 6 is a diagram illustrating an example of second display information displayed on the user terminal;

FIG. 7 is a diagram illustrating an example of related material information stored in the storage unit;

FIG. 8 is a flowchart illustrating an example of processing in the document management system;

FIG. 9 is a diagram illustrating an example of third display information displayed on the user terminal;

FIG. 10 is a flowchart illustrating an example of processing in the document management system; and

FIG. 11 is a diagram illustrating an example of a hardware configuration of a computer.

### DESCRIPTION

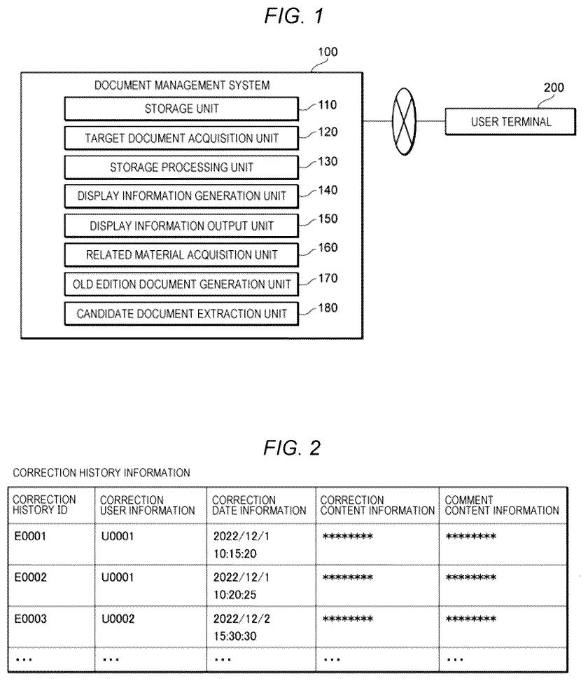

A preferred embodiment of the present disclosure will be described with reference to the accompanying drawings. FIG. 1 is a diagram illustrating a configuration of a document management system 100 according to the embodiment of the present disclosure. The document management system 100 is communicably connected to a user terminal 200 through a network, such as the Internet. Details of the document management system 100 will be described later.

The document management system 100 of the present embodiment is an information processing system implemented by a document management program, and is an information processing system that acquires a plurality of pieces of target document information belonging to a series of correction processes and stores the target document information in a predetermined storage unit in association with order information indicating the order of the series of correction processes. In other words, the document management system 100 can receive, for example, collective upload of the plurality of pieces of target document information by a user, and store the collective upload of the plurality of pieces of target document information in association with the order information.

In addition, the document management system 100 of the present embodiment is an information processing system that acquires at least one piece of target document information and related material information related to the at least one piece of target document information, and stores the at least one piece of target document information and the related material information in the predetermined storage unit in association with each other. In other words, the document management system 100 can store, for example, the target document information and the related material information acquired from the user in association with each other.

In addition, the document management system 100 of the present embodiment is an information processing system that stores, in the predetermined storage unit, target document information including correction history information, at least one piece of candidate document information that is extracted on the basis of at least one piece of old edition document information that is a previous version of the target document information and belongs to the same series of correction processes as the target document information, and the order information indicating the order of the correction processes, in association with one another. In other words, the document management system 100 can store, for example, the candidate document information having a version different from that of the target document information from among the plurality of pieces of document information already stored, in association with the target document information.

In the information processing apparatus described in Japanese Laid-Open Patent Publication No. 2020-184271, it may be assumed that the acquisition information and the storage information are transmitted to the target person. Therefore, a user may use appropriate acquisition information and storage information when managing the stored document and the created document in association with each other, and the convenience of the user may be limited.

Therefore, an object of an embodiment of the present disclosure is to provide a document management method, a document management system, and a document management program capable of more easily associating a plurality of pieces of document information.

According to the present disclosure, it may be possible to provide a document management method, a document management system, and a document management program capable of more easily associating a plurality of pieces of document information.

In the present specification, the correction process refers to a process including a plurality of pieces of document information appropriate to be managed as a series of cases. Therefore, the correction process is not limited to a process including certain document information and document information in which the certain document information is corrected, and even though pieces of document information belong to the same series of correction processes, document information of a later version may not be necessarily created by correcting document information of a previous version.

Note that it may not be necessary that all the pieces of document information belonging to one correction process have different contents, and a plurality of pieces of document information having the same contents may be included. Furthermore, in the present specification, the correction history may include a history of changes of document information other than correction, such as addition, insertion, deletion, rearrangement of the order of paragraphs and sentences, change of format, and change of various kinds of metadata.

The user terminal 200 of the present embodiment may be a computer used by the user of the document management system 100, and is a smartphone, a tablet terminal, a personal computer, or the like.

Note that, although only one user terminal 200 may be illustrated in FIG. 1, a plurality of user terminals 200 may be provided. In addition, a plurality of users may use one user terminal 200, or one user may use a plurality of user terminals 200.

Next, details of the document management system 100 of the present embodiment will be described. The document management system 100 may include a storage unit 110, a target document acquisition unit 120, a storage processing unit 130, a display information generation unit 140, a display information output unit 150, a related material acquisition unit 160, an old edition document generation unit 170, and a candidate document extraction unit 180. Each unit illustrated in FIG. 1 can be implemented, for example, by use of a storage area or by a processor executing a program stored in the storage area.

The storage unit 110 of the present embodiment may store information to be processed in the document management system 100. The storage unit 110 can store, for example, target document information, related material information, candidate document information, correction history information, and old edition document information, which will be described later.

The target document acquisition unit 120 of the present embodiment may acquire the target document information. The target document acquisition unit 120 may acquire one piece of target document information or may acquire a plurality of pieces of target document information. Details of the target document acquisition unit 120 will be described later.

The target document information of the present embodiment may be document information to be processed by the document management system 100. The document information of the present embodiment may be, for example, document information of a legal document such as a contract. The document information may be, for example, document information on a contract created by a predetermined electronic document creation software, document information resulting from digitization of a contract on a paper medium using a predetermined image analysis technology (an optical character recognition (OCR) technology, for example), or document information generated by the document management system 100, an external system, or using a template or a document creation function (editor function or the like) provided by a service. In addition, the documents to be processed by the document management system 100 may include legal documents such as regulations, bylaws, and contracts. The contract may include a document that includes clauses and causes a predetermined legal effect, and include an application form, a memorandum, or the like. In the present specification, the contract may be described as an example of the document information, but it can be appropriately applied to other document information.

The contract may include not only a contract agreed to and concluded by both parties but also a contract being confirmed by both parties (namely, a contract proposal), a contract that has been exchanged between the parties but has not reached an agreement, or a contract template created for reference in contract with another party. In the description of the present embodiment, unless otherwise particularly specified, the term “contract” may mean a contract agreed to by both parties, a contract being confirmed by both parties (namely, a contract proposal), a contract that has been exchanged between the parties but has not reached an agreement, or a contract template created for reference in contract with another party. In addition, in the present embodiment, the target document information may be a confirmed contract or the latest version of contract, or may be a contract that is not the latest version.

The document information may include, for example, text, figure, or table data indicating the contents of the document.

In addition, the document information may further include title information indicating the title of the document, status information indicating the status of the document (for example, reviewed, agreed, other-party correction proposal, other-party draft, primary proposal, or template), type information indicating the type of the contract, position information indicating the position of the contract, and tag information indicating a tag attached according to the contents of the document.

Here, the title of the present embodiment may be, for example, a file name of the document information, or may be a heading (for example, “confidentiality agreement” or the like) of a document (contract or the like) indicated by the document information.

Furthermore, the status of the present embodiment may be, for example, a status of document review. In a case where the document information is document information of a contract, upon agreement between contracting parties, one or both of the contracting parties may review (inspect) and correct the contract. As an example, in the case of a contract between companies, for example, the legal department in charge of contract inspection may inspect the contents of the contract and corrects the contract as necessary. Note that such inspection may be also referred to as confirmation or examination.

In addition, the type of the present embodiment may be, for example, the type (category) of the contents of the document information. For example, in a case where the document information is a contract, the type may be information indicating a type (sometimes referred to as a form) of contract contents such as a “confidentiality agreement” or a “service agreement”. In addition, the position of the present embodiment may be information indicating contractual position such as “disclosing party” or “outsourcing party”.

Furthermore, the tag of the present embodiment may, for example, simply indicate the contents of the document information. The tag may be set, for example, to classify the document information. The tag may be set as, for example, a sub-category set for each type (category). That is, in a case where the type is “service agreement”, the tag may be “human resources placement”, “software development”, or the like, which are specific contents of the service agreement. One or a plurality of pieces of tag information may be set in the document information.

Note that the title information, the status information, the type information, the position information, and the tag information may be information set in accordance with an input from the user, or may be information extracted based on analysis of the target document information by an information processing system (for example, the document management system 100).

In addition, the language of the target document information may be, for example, Japanese, English, or any other language.

Furthermore, the target document acquisition unit 120 can acquire target document information including correction history information regarding a history of correction.

The correction history information of the present embodiment may be, for example, information regarding a history of correction made to the document information in response to the review by the user. The correction history information may include, for example, correction user information indicating a user who has made correction, correction date information indicating a date of correction, correction content information indicating contents of correction, and comment content information indicating contents of a comment given at the time of correction. In addition, the correction history information may further include related information to be described later.

FIG. 2 is a diagram illustrating an example of the correction history information of the present embodiment. The correction history information of the present embodiment may include, for example, a correction history ID, correction user information, correction date information, correction content information, and comment content information. The correction history ID may be information for identifying a correction history indicated by the correction history information.

The storage processing unit 130 of the present embodiment may perform storage processing of document information.

The storage processing unit 130 may store the plurality of pieces of document information in a predetermined storage unit (for example, the storage unit 110 or a storage unit of an external information processing system) in association with the order information indicating the order of the series of correction processes.

For example, the storage processing unit 130 may first associate the same sequence ID with each of the plurality of pieces of document information belonging to the series of correction processes, and further associate the order information with each of the plurality of pieces of document information belonging to the series of correction processes. As a result, the document management system 100 can recognize to which correction process the document information belongs and in which order the document information is.

Here, the sequence ID of the present embodiment may be information for identifying a sequence. The sequence of the present embodiment may be information indicating the series of correction processes. That is, a plurality of pieces of target document information belonging to the same sequence may indicate that the plurality of pieces of target document information belongs to the same series of correction processes. In addition, the order information of the present embodiment may include status information, or may include numerical information such as “1” and “2”.

Details of the storage processing unit 130 will be described later.

The display information generation unit 140 of the present embodiment may generate display information for displaying a predetermined screen.

The display information output unit 150 of the present embodiment may output the display information. The display information output unit 150 can output the display information, for example, to the user terminal 200.

Details of the display information generation unit 140 and the display information output unit 150 will be described later.

First, a “collective acquisition function” in the document management system 100 will be described. In the “collective acquisition function”, the document management system 100 may acquire the plurality of pieces of target document information belonging to the series of correction processes, and store the plurality of pieces of target document information in the predetermined storage unit in association with the order information indicating the order of the series of correction processes.

The target document acquisition unit 120 may collectively acquire the plurality of pieces of target document information belonging to the series of correction processes. Note that, in the present specification, “collective” may not be limited to acquiring all of the series of correction processes at once, and a part of the series of correction processes may be omitted, or may be acquired a plurality of times.

In addition, the target document acquisition unit 120 can acquire a folder including the plurality of pieces of target document information and collectively acquire the plurality of pieces of target document information. At this time, the folder may include, for example, a folder (in other words, a child folder) including at least one piece of target document information of the plurality of pieces of target document information.

For example, the target document acquisition unit 120 may acquire the target document information from the user terminal 200, or may acquire the target document information from a predetermined information processing system or storage device according to an instruction of the user terminal 200.

The storage processing unit 130 of the present embodiment may store the plurality of pieces of target document information in a predetermined storage unit (for example, the storage unit 110 or a storage unit of an external information processing system) in association with the order information indicating the order of the series of correction processes. That is, the storage processing unit 130 can store the plurality of pieces of target document information in association with the version of the document.

Specifically, for example, the storage processing unit 130 may first associate the same sequence ID with each of the plurality of pieces of target document information belonging to the series of correction processes, and may further associate the order information with each of the plurality of pieces of target document information belonging to the series of correction processes. As a result, the document management system 100 can recognize to which correction process the target document information belongs and in which order the target document information is.

For example, the storage processing unit 130 can store the plurality of pieces of target document information in the predetermined storage unit in association with the order information, assuming that the pieces of target document information are corrected in the order of a creation time or an update time on the basis of the information indicating the creation time or the update time of the respective plurality of pieces of target document information.

In addition, for example, the storage processing unit 130 can analyze the contents (for example, text) of the plurality of pieces of target document information, and store the plurality of pieces of target document information in the predetermined storage unit in association with the order information on the basis of the correction history of the contents. Specifically, for example, the storage processing unit 130 can process target document information that does not include the correction history as the oldest version of document information, and can process the pieces of target document information assuming that the documents have been updated in the order of increasing correction history. As a result, the document management system 100 can manage the pieces of target document information in an appropriate order, for example, even in a case where the order of the update times and the order of the versions do not match.

In addition, for example, the storage processing unit 130 can store the plurality of pieces of target document information in the predetermined storage unit in association with the order information on the basis of the title information (particularly, for example, a file name) of each of the plurality of pieces of target document information. Specifically, for example, the storage processing unit 130 can recognize that target document information including a “secondary proposal” in the title information is the target document information created after target document information including a “primary proposal” in the title information, and store the target document information in the predetermined storage unit.

Furthermore, for example, in a case where the title information includes information of date, the storage processing unit 130 can recognize the date and store the date in the predetermined storage unit in association with the order information along the date.

In addition, in a case where the target document acquisition unit 120 acquires a folder, the storage processing unit 130 can store the plurality of pieces of target document information in the predetermined storage unit in association with the order information on the basis of hierarchy information indicating a predetermined hierarchy in the folder. Specifically, in a case where the folder includes a plurality of folders, and the titles of the plurality of folders are “first proposal” and “second proposal”, the target document information stored in the folder “second proposal” can be recognized as target document information created after the target document information stored in the folder “first proposal”, and can be stored in the predetermined storage unit.

In addition, in a case where the target document acquisition unit 120 acquires a folder, the storage processing unit 130 can sequentially acquire a plurality of pieces of target document information included in the folder in chronological order, and store the plurality of pieces of target document information in the predetermined storage unit in association with the order information. At this time, for example, the storage processing unit 130 may acquire the plurality of pieces of target document information in the order of the creation date and time or the update date and time of each of the plurality of pieces of target document information.

In addition, according to an execution operation by the user who has received display of first display information to be described later, the storage processing unit 130 can store the plurality of pieces of target document information in the predetermined storage unit in association with the order information so as to correspond to the display.

The display information generation unit 140 of the present embodiment may generate the first display information for displaying a screen for associating a plurality of pieces of document information and order information on the user terminal 200, and store the first display information in the storage unit 110.

The display information output unit 150 of the present embodiment may output the first display information. The display information output unit 150 can output the first display information, for example, to the user terminal 200.

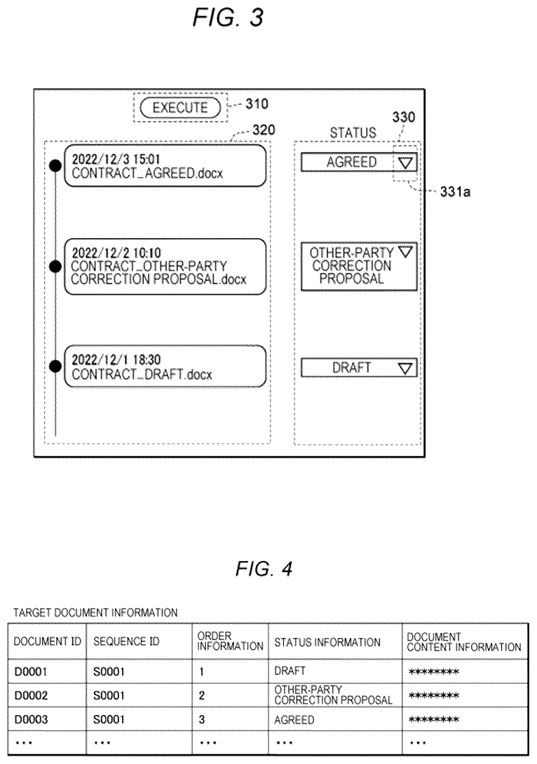

FIG. 3 is a diagram illustrating an example of the first display information displayed on the user terminal 200. The screen illustrated in FIG. 3 may include, for example, an area 310 for displaying a button for executing association between the plurality of pieces of target document information and the order information, an area 320 for displaying information regarding the plurality of pieces of target document information in association with the order information, and an area 330 for displaying status information of each of the plurality of pieces of target document information.

In the present embodiment, when the area 310 is selected by the user, the plurality of pieces of target document information may be stored in the predetermined storage unit in association with the order information according to the displayed association between the plurality of pieces of target document information and the order information.

In the area 320, for example, title information and creation time information or update time information of the plurality of pieces of target document information may be displayed as the information regarding the plurality of pieces of target document information. Note that the information regarding the plurality of pieces of target document information to be displayed may not be limited thereto.

In the area 320 of the present embodiment, first, the plurality of pieces of target document information may be displayed in association with the order information according to an analysis result of the target document information by the storage processing unit 130.

For example, the user can select and move (for example, so-called drag operation) an area, which is included in the area 320 and in which the information regarding the plurality of pieces of document information is displayed, to switch the order of the plurality of pieces of target document information. As a result, even in a case where the association by the storage processing unit 130 is inappropriate, the user can associate the plurality of pieces of target document information with the appropriate order information.

In the area 330, for example, status information corresponding to each of the plurality of pieces of target document information may be displayed. The status information displayed in the area 330 may be, for example, information extracted through analysis of target document information by an information processing system (for example, the document management system 100). Furthermore, the status information displayed in the area 330 may be changed by an operation (for example, pressing of a button and a selection operation from a pull-down menu) of a predetermined button (for example, a button displayed in an area 331a) displayed in the area 330, or the like, or an input, the operation and the input being performed by the user who has received the display of the screen illustrated in FIG. 3.

FIG. 4 is a diagram illustrating an example of the target document information stored in the storage unit 110. The document information stored in the storage unit 110 may include, for example, a document ID, a sequence ID, the order information, the status information, and document content information.

The document ID of the present embodiment may be information for identifying the target document information to be processed in the document management system 100. The document content information of the present embodiment may be information indicating contents (for example, text, figures, and tables) of the document information (in this case, the target document information).

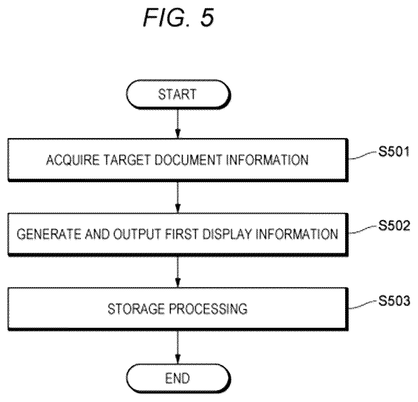

FIG. 5 is a flowchart illustrating an example of processing in the document management system 100. The flowchart illustrated in FIG. 5 may be an example of a flowchart in the “collective acquisition function” in the document management system 100.

First, the target document acquisition unit 120 may acquire a plurality of pieces of target document information (S501). The display information generation unit 140 may generate the first display information, and the display information output unit 150 may output the first display information (S502). The storage processing unit 130 may store the plurality of pieces of target document information in the predetermined storage unit in association with the order information according to the operation of the user who has received the display of the first display information (S503).

Next, a “related material acquisition function” in the document management system 100 will be described. In the “related material acquisition function”, the document management system 100 may acquire at least one piece of target document information and related material information related to the at least one piece of target document information, and store the at least one piece of target document information and the related material information in the predetermined storage unit in association with each other.

The target document acquisition unit 120 of the present embodiment may acquire at least one piece of target document information.

The related material acquisition unit 160 of the present embodiment may acquire related material information related to at least one piece of target document information, and store the related material information in the storage unit 110. The related material acquisition unit 160 can acquire the related material information in response to the acquisition of at least one piece of target document information by the target document acquisition unit 120. That is, the document management system 100 (in particular, the target document acquisition unit 120 and the related material acquisition unit 160) can collectively acquire at least one piece of target document information and the related material information.

More specifically, for example, the user may upload the target document information and the related material information to the document management system 100. Then, the document management system 100 (in particular, the target document acquisition unit 120 and the related material acquisition unit 160) may collectively acquire the uploaded target document information and related material information.

The related material information of the present embodiment may be document information related to at least one piece of target document information. In a case where the target document information is document information of a contract, the related material information may be, for example, a memo, an explanatory material, a review material, or the like used in creation, correction, or conclusion of the contract. The related material information may include, for example, public information disclosed on the outside (for example, the Internet or the like), information described in a publication such as a book or a magazine, information provided through a predetermined information processing service (for example, a contract review service or a response service by an expert), and past contracts or provisions of the user. As a result, the user can manage and refer to the target document information and the material used to, for example, create the target document information in association with each other.

The related material information may be, for example, information in a file format different from at least one piece of target document information. That is, in a case where the document information is, for example, a file in a portable document format (PDF) or a document file created using so-called word processing software (document creation software) such as Word, the related material information may be, for example, a file in an image format, a file created using spreadsheet software, or a file in a slide format created using presentation software. As a result, the document management system 100 can manage the target document information and the related material information having different file formats.

At this time, the document management system 100 can acquire the file as the target document information or as the related material information on the basis of the file format of the file to be acquired. That is, in a case where the document management system 100 acquires, for example, a PDF file or a document file created using so-called word processing software, the document management system 100 (in particular, the target document acquisition unit 120) may acquire the file as the target document information, and in a case where the document management system 100 acquires, for example, a file in an image format, a file created using spreadsheet software, or a file in a slide format, the document management system 100 (in particular, the related material acquisition unit 160) may acquire the file as the related material information. As a result, the document management system 100 can appropriately acquire the file on the basis of the file format.

The storage processing unit 130 may store at least one piece of target document information and the related material information in the predetermined storage unit (for example, the storage unit 110 or a storage unit of an external information processing system) in association with each other. As a result, the user can manage the related information indicating the basis and circumstances of the creation, correction, or conclusion of the at least one piece of target document information in association with the at least one piece of target document information in unit of the at least one piece of target document information. At this time, the at least one piece of target document information may include correction history information.

In addition, the storage processing unit 130 can store the plurality of pieces of target document information belonging to a series of correction processes, the order information indicating the order of the series of correction processes, and the related material information in association with one another. As a result, the user can manage the related information indicating the basis and circumstances of the creation, correction, or conclusion of the plurality of pieces of target document information belonging to the series of correction processes in association with the plurality of pieces of target document information belonging to the series of correction processes in units of the series of correction processes.

The display information generation unit 140 may generate second display information for displaying a screen for associating at least one piece of target document information and related material information on the user terminal 200, and store the second display information in the storage unit 110. In addition, the display information generation unit 140 can generate the second display information for displaying, on the user terminal 200, a screen for associating the plurality of pieces of target document information belonging to the series of correction processes, the order information indicating the order of the series of correction processes, and the related material information.

The display information output unit 150 may output the second display information. The display information output unit 150 can output the second display information, for example, to the user terminal 200.

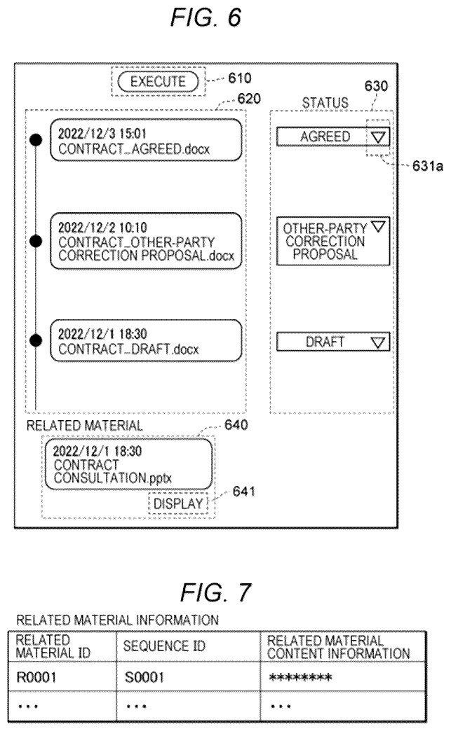

FIG. 6 is a diagram illustrating an example of the second display information displayed on the user terminal 200. The screen illustrated in FIG. 6 may include, for example, an area 610 for displaying a button for executing association among the plurality of pieces of target document information belonging to the series of correction processes, the order information indicating the order of the series of correction processes, and the related material information, an area 620 for displaying information regarding the plurality of pieces of target document information in association with the order information, an area 630 for displaying status information of each of the plurality of pieces of target document information, and an area 640 for displaying information regarding the related material information.

In the present embodiment, when the area 610 is selected by the user, the plurality of pieces of document information, the order information, and the related material information may be stored in the predetermined storage unit in association with one another according to the displayed association among the plurality of pieces of target document information, the order information, and the related material information.

In the area 620, for example, title information and creation time information or update time information of the plurality of pieces of target document information may be displayed as the information regarding the plurality of pieces of target document information. Note that the information regarding the plurality of pieces of target document information to be displayed is not limited thereto.

In the area 620 of the present embodiment, first, the plurality of pieces of target document information may be displayed in association with the order information according to an analysis result of the target document information by the storage processing unit 130.

For example, the user can select and move (for example, so-called drag operation) an area, which is included in the area 620 and in which the information regarding the plurality of pieces of target document information is displayed, to switch the order of the plurality of pieces of target document information. As a result, even in a case where the association by the storage processing unit 130 is inappropriate, the user can associate the plurality of pieces of target document information with the appropriate order information.

In the area 630, for example, status information corresponding to each of the plurality of pieces of target document information may be displayed. The status information displayed in the area 630 may be, for example, information extracted through analysis of target document information by an information processing system (for example, the document management system 100). Furthermore, the status information displayed in the area 630 may be changed by an operation (for example, pressing of a button and a selection operation from a pull-down menu) of a predetermined button (for example, a button displayed in an area 631a) displayed in the area 630, or the like, or an input, the operation and the input being performed by the user who has received the display of the screen illustrated in FIG. 6.

In the area 640, for example, title information and creation time information or update time information of the related material information may be displayed as the information regarding the related material information. Note that the information regarding the related material information to be displayed is not limited thereto. In addition, in the area 640, a plurality of pieces of information regarding one piece of related material information may be displayed, or information regarding a plurality of pieces of related material information may be displayed.

In an area 641 included in the area 640, a button for displaying the corresponding related material information may be displayed. That is, when the user selects the area 641, the contents of the corresponding related material information may be displayed. As a result, with reference to the contents of the related material information, the user can determine whether to associate the related material information with the target document information.

FIG. 7 is a diagram illustrating an example of the related material information stored in the storage unit 110. The related material information stored in the storage unit 110 may include, for example, a related material ID, a sequence ID, and related material content information. The related material ID of the present embodiment may be information for identifying the related material information to be processed in the document management system 100. The related material content information may be information indicating contents (for example, text, figures, and tables) of the related material information.

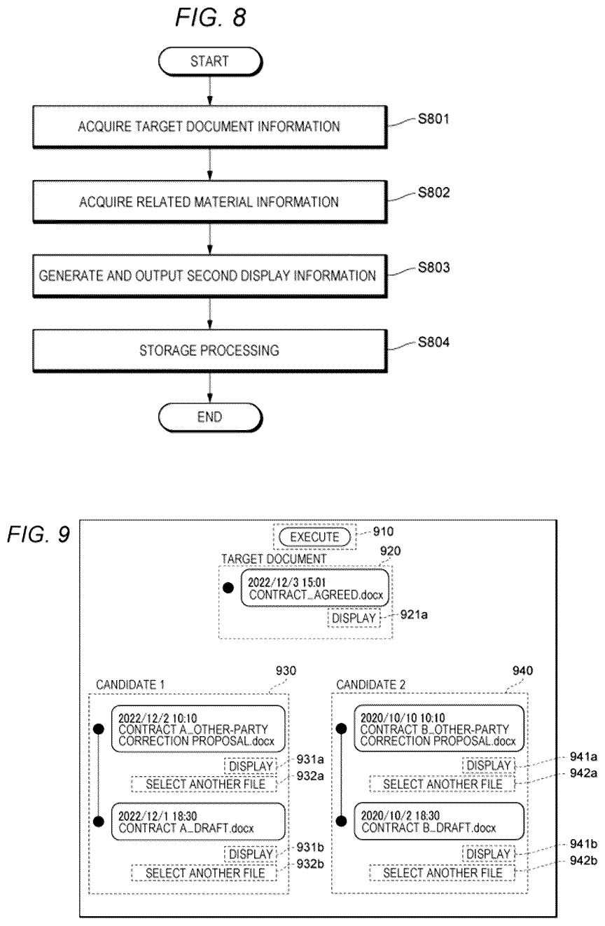

FIG. 8 is a flowchart illustrating an example of processing in the document management system 100. The flowchart illustrated in FIG. 8 may be an example of a flowchart in the “related material acquisition function” in the document management system 100.

First, the target document acquisition unit 120 may acquire target document information (S801). The related material acquisition unit 160 may acquire the related material information (S802). The display information generation unit 140 may generate the second display information, and the display information output unit 150 may output the second display information (S803). The storage processing unit 130 may store the target document information and the related material information in association with each other (S804).

Next, a “version candidate suggestion function” in the document management system 100 will be described. In the “version candidate suggestion function” of the present embodiment, the document management system 100 may store, in the predetermined storage unit, target document information including correction history information, at least one piece of candidate document information that is extracted on the basis of at least one piece of old edition document information, which is a previous version of the target document information, and belong to the same series of correction processes as the target document information, and the order information indicating the order of the correction processes, in association with one another.

The target document acquisition unit 120 of the present embodiment may acquire the target document information including the correction history information regarding a history of correction.

On the basis of the correction history information included in the target document information, the old edition document generation unit 170 of the present embodiment may generate at least one piece of old edition document information that is a previous version of the target document information according to the correction process corresponding to the history of correction, and store the at least one piece of old edition document information in the storage unit 110.

The old edition document information of the present embodiment may be information regarding a document of a version before the target document information is corrected.

The old edition document generation unit 170 can generate an old edition document on the basis of a predetermined standard such as a date and time or a user. For example, the old edition document generation unit 170 may regard a plurality of corrections made on the same date as one correction group on the basis of the correction history information, and generate the old edition document information for each correction group (that is, for each correction date). In addition, for example, the old edition document generation unit 170 may regard a plurality of corrections continuously made by the same user as one correction group on the basis of the correction history information, and generate the old edition document information for each correction group (that is, for each continuous correction by the same user). As a result, the document management system 100 can generate the old edition document information for each set of corrections, and the user can refer to the old edition document information for each meaningful set. The generated old edition document may be stored, or may not be stored, for example, because the old edition document generated by the system has not enough changes to become as an old edition. This may be determined and operated by the user, or may be determined by the system by determining a difference between a plurality of files generated as consecutive versions and determining whether the similarity is equal to or greater than a certain level.

The candidate document extraction unit 180 of the present embodiment may extract at least one candidate document that may belong to the same series of correction processes as the target document information. In particular, for example, the candidate document extraction unit 180 may extract at least one piece of candidate document information belonging to the same series of correction processes as the target document information from among a plurality of pieces of document information stored in the predetermined storage unit (for example, the storage unit 110 or a storage unit in an external information processing system) on the basis of at least one piece of old edition document information.

In reviewing the document information, there may be a case where the user appropriately stores the corrected document information in the predetermined storage unit. That is, for example, the user may store document information drafted by its own company, store document information corrected by the other party, and further store document information corrected by its own company. Conventionally, when storing the corrected document information in association with document information of another version (for example, a previous version), a user may have needed to designate the document information of another version.

Therefore, the candidate document extraction unit 180 may extract, as the candidate document information, the document information of another version to be associated with the target document information to be stored. Here, the candidate document information may be document information generated on the basis of the target document information and the correction history information included in the target document information. That is, the candidate document information can be regarded as a candidate of the document information of the previous version to be associated with the target document information to be stored, and the document management system 100 may extract the candidate document information to propose a candidate of the document information of a different version from the target document information to be associated with the target document information.

Note that, in a case where document information that is a later version of the target document information exists, the candidate document extraction unit 180 may extract a candidate of the document information of the later version.

The candidate document extraction unit 180 can extract at least one piece of candidate document information further on the basis of similarity to at least one piece of old edition document information. Specifically, the candidate document extraction unit 180 can calculate the similarity between the plurality of pieces of document information stored in the predetermined storage unit and at least one piece of old edition document information, and extract document information having the highest similarity as the candidate document information.

The candidate document extraction unit 180 may extract one piece of candidate document information that is the previous version or is most likely to belong to the correction process. At this time, at least one piece of candidate document information belonging to one correction process may be extracted. In this case, the candidate document extraction unit 180 may extract at least one piece of candidate document information belonging to the series of correction processes (that is, including the same sequence ID) to which the candidate document information having the highest similarity belongs.

In addition, the candidate document extraction unit 180 may extract at least one piece of candidate document information belonging to each of a plurality of correction processes. In this case, the candidate document extraction unit 180 may extract at least one piece of candidate document information belonging to the plurality of correction processes (that is, including the different sequence ID) to which the plurality of pieces of candidate document information each having a predetermined similarity belongs. Furthermore, at this time, the candidate document extraction unit 180 may extract at least one piece of candidate document information belonging to the plurality of correction processes in descending order of similarity. As a result, the user can receive a proposal of a plurality of candidates as the document information corresponding to the previous version of the target document information through the processing of the document management system 100, and can more easily associate the appropriate candidate document information with the target document information.

Here, the similarity of the present embodiment may be information indicating a degree of similarity between pieces of document information. The similarity may be calculated, for example, according to the Levenshtein distance, may be calculated according to the degree of similarity between title information, status information, type information, position information, or tag information of the pieces of document information, or may be calculated by a predetermined technique.

The display information generation unit 140 of the present embodiment may generate third display information for displaying a screen for associating target document information, at least one piece of candidate document information, and order information on the user terminal 200, and stores the third display information in the storage unit 110.

The display information generation unit 140 may generate the third display information for displaying the target document information, at least one piece of candidate document information belonging to one correction process, and the order information. At this time, for example, the display information generation unit 140 may generate the third display information for displaying a screen for associating a series of pieces of candidate document information belonging to the correction process to which the candidate document information having the highest similarity belongs on the basis of the old edition document information. As a result, the user can easily associate the target document information, the candidate document information having the highest similarity, and the order information.

In addition, the display information generation unit 140 may generate the third display information for displaying the target document information, the plurality of pieces of candidate document information belonging to the plurality of correction processes, and the order information. At this time, for example, the display information generation unit 140 may generate the third display information for displaying a screen for associating the plurality of pieces of candidate document information belonging to the plurality of correction processes to which the plurality of pieces of candidate document information each having a predetermined similarity belongs on the basis of the old edition document information, or associating the plurality of pieces of candidate document information belonging to the plurality of correction processes having a predetermined similarity on the basis of the old edition document information. That is, in this case, the display information generation unit 140 may generate the third display information for displaying a plurality of correction process candidates when associating the target document information on the screen, and the user who refers to the display based on the third display information selects a correction process to be associated with the target document information from among the plurality of correction process candidates. As a result, the user can select the correction process to be associated with the target document information from among the plurality of correction process candidates, and can easily associate the target document information, the candidate document information, and the order information.

The display information output unit 150 may output the third display information. The display information output unit 150 can output the third display information, for example, to the user terminal 200.

FIG. 9 is a diagram illustrating an example of the third display information displayed on the user terminal 200. The screen illustrated in FIG. 9 may include, for example, an area 910 for displaying a button for executing association among the target document information, at least one candidate document information, and the order information, an area 920 for displaying information regarding the target document information, and areas 930 and 940 for displaying information regarding the candidate document information in association with the order information.

For example, when the user selects a candidate displayed in the area 930, the display format of the area 930 may be changed to a display format indicating that the area 930 is selected. The format indicating that the area 930 is selected may be, for example, a display format different from that of the unselected area 940, and may be, for example, a display format in which the color of the display of the area 930 is different or a display format in which the color or shape of the display of a frame of the area 930 is different.

Note that, in the screen illustrated in FIG. 9, although two correction process candidates are displayed, the number of displayed correction process candidates is not limited thereto.

In the present embodiment, when the area 910 is selected by the user, according to the association among the target document information, at least one candidate document information, and the order information that are selected, the target document information and the at least one candidate document information may be stored in the predetermined storage unit in association with the order information.

In the area 920 of the present embodiment, for example, title information and creation time information or update time information of the target document information may be displayed as the information regarding the target document information. Note that the information regarding the target document information to be displayed is not limited thereto.

In an area 921a of the present embodiment, a button for displaying the target document information may be displayed. When the user selects the area 921a, the target document information may be displayed. As a result, the user can easily refer to the contents of the target document information from the display screen based on the third display information.

In the areas 930 and 940 of the present embodiment, for example, title information and creation time information or update time information of each of the plurality of pieces of candidate document information may be displayed as the information regarding the plurality of pieces of candidate document information. Note that the information regarding the plurality of pieces of candidate document information to be displayed is not limited thereto.

In the area 930 of the present embodiment, for example, information regarding the plurality of pieces of candidate document information belonging to a series of correction processes to which the candidate document information (in this case, for example, “contract A”) having the highest similarity belongs may be displayed as “candidate 1”. In addition, in the area 940, for example, information regarding the plurality of pieces of candidate document information belonging to a series of correction processes to which the candidate document information (in this case, for example, “contract B”) having the next highest similarity belongs may be displayed as “candidate 2”.

The user may select either the area 930 or the area 940 as the candidate document information corresponding to the target document information corresponding to the display of the area 920, and select the execution button of the area 910. The area 930 or the area 940 may be displayed in a different manner (for example, highlighted) in a case of being selected by the user. As a result, the user can visually grasp the candidate document information selected by the user.

In areas 931a and 931b included in the area 930 and areas 941a and 941b included in the area 940 of the present embodiment, buttons for displaying the corresponding candidate document information may be displayed. That is, when the user selects one of the areas, the contents (for example, text) of the corresponding candidate document information may be displayed. As a result, with reference to the contents of the candidate document information, the user can determine whether to associate the candidate document information with the target document information.

In addition, in areas 932a and 932b included in the area 930 and areas 942a and 942b included in the area 940 of the present embodiment, buttons for selecting document information different from the displayed candidate document information may be displayed. That is, when the user selects one of the areas, the user can select the document information stored in the predetermined storage unit. As a result, when the candidate document information extracted by the candidate document extraction unit 180 does not belong to the same series of correction processes as the target document information, the user can manually select the document information belonging to the same series of correction processes as the target document information from among the document information stored in the predetermined storage unit.

For example, the user can select and move (for example, so-called drag operation) an area, which is included in the area 930 or the area 940 and in which the information regarding the candidate document information is displayed, or the like to switch the order of the pieces of document information. As a result, even in a case where the association by the storage processing unit 130 is inappropriate, the user can associate the candidate document information with the appropriate order information.

In addition, the screen illustrated in FIG. 9 may further include an area in which status information corresponding to each of the target document information and the candidate document information may be displayed. Furthermore, the status information displayed in the area may be changed by an operation (for example, pressing of a button and a selection operation from a pull-down menu) of a predetermined button (for example, a button displayed in an area), or an input, the operation and the input being performed by the user who has received the display of the screen illustrated in FIG. 9.

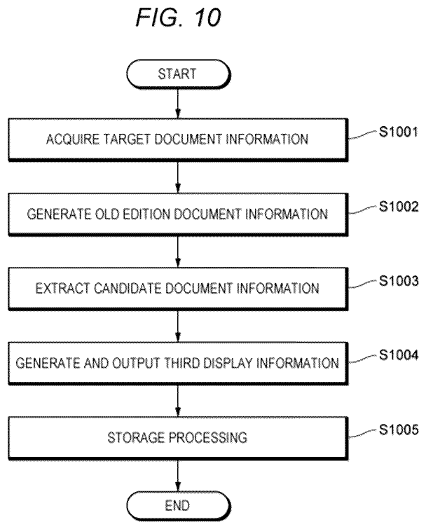

FIG. 10 is a flowchart illustrating an example of processing in the document management system 100. The flowchart illustrated in FIG. 10 may be an example of a flowchart in the “version candidate suggestion function” in the document management system 100.

First, the target document acquisition unit 120 may acquire target document information including correction history information (S1001). The old edition document generation unit 170 may generate at least one piece of old edition document information on the basis of the correction history information included in the target document information (S1002). The candidate document extraction unit 180 may extract at least one piece of candidate document information belonging to the same series of correction processes as the target document information on the basis of at least one piece of old edition document information (S1003).

Subsequently, the display information generation unit 140 may generate the third display information, and the display information output unit 150 may output the third display information (S1004). The storage processing unit 130 may store the target document information and the candidate document information in association with the order information according to the operation of the user who has received the display of the third display information (S1005).

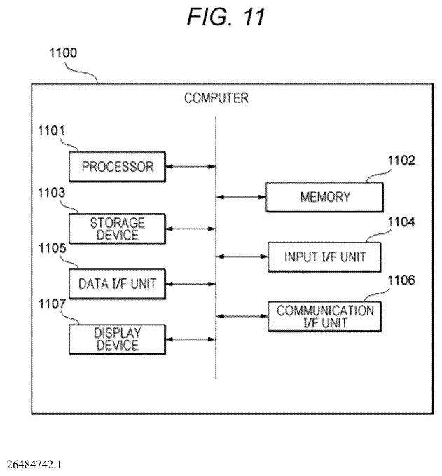

Next, an example of a hardware configuration in a case where the document management system 100 may be implemented by a computer 1100 will be described with reference to FIG. 11. FIG. 11 is a diagram illustrating an example of a hardware configuration of the computer 1100.

As illustrated in FIG. 11, the computer 1100 may include, for example, a processor 1101, a memory 1102, a storage device 1103, an input I/F unit 1104, a data I/F unit 1105, a communication I/F unit 1106, and a display device 1107.

The computer 1100 may be, for example, a server computer, a personal computer (for example, a desktop, a laptop, a tablet, or the like), a media computer platform (for example, a cable, a satellite set-top box, a digital video recorder, or the like), a handheld computer device (for example, a PDA, an e-mail client, or the like), or another type of computer or communication platform.

The processor 1101 may be a control unit that controls various types of processing in the computer 1100 by executing a program stored in the memory 1102.

The memory 1102 may be, for example, a storage medium such as a random access memory (RAM). The memory 1102 temporarily may store a program code of a program executed by the processor 1101 and data required at the time of executing the program.

The storage device 1103 may be, for example, a nonvolatile storage medium such as a hard disk drive (HDD) or a flash memory. The storage device 1103 may store an operating system and various programs for implementing the above configurations.

The input I/F unit 1104 may be a device for receiving an input from a user. The input I/F unit 1104 may be, for example, a keyboard, a mouse, a touch panel, various sensors, a wearable device, or the like. The input I/F unit 1104 may be connected to the computer 1100 via, for example, an interface such as a universal serial bus (USB).

The data I/F unit 1105 may be a device for inputting data from the outside of the computer 1100. The data I/F unit 1105 may be, for example, a drive device or the like for reading data stored in various storage media. The data I/F unit 1105 may be provided outside the computer 1100. In a case where the data I/F unit 1105 is provided outside the computer 1100, the data I/F unit 1105 may be connected to the computer 1100 via, for example, an interface such as USB.

The communication I/F unit 1106 may be a device for performing data communication via a network such as the Internet with a device outside the computer 1100 in a wired or wireless manner. The communication I/F unit 1106 may be provided outside the computer 1100. In a case where the communication I/F unit 1106 is provided outside the computer 1100, the communication I/F unit 1106 may be connected to the computer 1100 via, for example, an interface such as USB.

The display device 1107 may be a device for displaying various types of information. The display device 1107 may be, for example, a liquid crystal display, an organic electro-luminescence (EL) display, a display of a wearable device, or the like. The display device 1107 may be provided outside the computer 1100. In a case where the display device 1107 is provided outside the computer 1100, the display device 1107 may be connected to the computer 1100 via, for example, a display cable or the like. In addition, in a case where a touch panel is employed as the input I/F unit 1104, the display device 1107 may be integrated with the input I/F unit 1104.

The embodiment of the present disclosure has been described above. The document management system 100 can collectively acquire a plurality of pieces of target document information belonging to a series of correction processes, and store the plurality of pieces of target document information in a predetermined storage unit in association with order information indicating the order of the series of correction processes. As a result, the user can more easily associate the plurality of pieces of target document information.

In addition, the document management system 100 can output first display information for displaying a screen for associating the plurality of pieces of target document information and the order information on the user terminal 200, and store the plurality of pieces of target document information in association with the order information on the basis of the operation of the user. As a result, the user can correct the order information as necessary, and associate the plurality of pieces of target document information and the order information.

In addition, the document management system 100 can acquire a folder including the plurality of pieces of target document information and collectively acquire the plurality of pieces of target document information. As a result, the user can more easily associate the plurality of pieces of target document information by uploading the folder, for example.

In addition, the document management system 100 can collectively acquire the plurality of pieces of target document information including status information. As a result, the document management system 100 can store the plurality of pieces of target document information and the order information in association with each other with reference to the status information.

In addition, the document management system 100 can collectively acquire at least one piece of target document information and related material information, and store the at least one piece of target document information and the related material information in the predetermined storage unit in association with each other. As a result, the user can more easily associate at least one piece of the target document information and the related material information.

In addition, the document management system 100 can collectively acquire the plurality of pieces of target document information belonging to the series of correction processes and related material information, and store the plurality of pieces of target document information, the order information indicating the order of the series of correction processes, and the related material information in association with one another. As a result, the user can more easily associate the plurality of pieces of target document information, the order information, and the related material information.

In addition, the document management system 100 can generate second display information for displaying a screen for associating at least one piece of target document information and the related material information on the user terminal 200, and store at least one piece of target document information and the related material information in association with each other on the basis of the operation of the user. As a result, the user can associate at least one piece of target document information and the related material information after confirming the result of the association processing by the document management system 100.

In addition, the document management system 100 can associate target document information regarding a contract with related material information in a file format different from the target document information. As a result, the user can manage, for example, the contract in the document format and the related material in the image format or the slide format referred to in the creation or conclusion of the contract, in association with each other.

In addition, the document management system 100 can acquire the target document information including the correction history information, extract at least one piece of candidate document information on the basis of at least one piece of old edition document information generated on the basis of the correction history information, and store the target document information, the candidate document information, and the order information in association with one another. As a result, the user can more easily associate the target document information with the old edition document information of the previous version of the target document information.

In addition, the document management system 100 can output third display information for displaying a screen for associating the target document information, the candidate document information, and the order information on the user terminal 200, and associate the target document information, the candidate document information, and the order information on the basis of the operation of the user. As a result, the candidate document information can be corrected as necessary, and the target document information, the candidate document information, and the order information can be associated with one another.

In addition, the document management system 100 can extract the candidate document information on the basis of the similarity to the old edition document information. As a result, the document management system 100 can extract more appropriate candidate document information as the document information of the previous version of the target document information.

In addition, the document management system 100 can output the third display information displaying the plurality of pieces of candidate document information in order of similarity. As a result, the user can more easily select the candidate document information.

Note that the present embodiment is intended for easy understanding of the present disclosure and thus is not intended to interpret the present disclosure in a limited manner. Modifications or alterations of the present disclosure may be made without departing from the gist of the present disclosure, and equivalents thereof are included in the present disclosure.

In addition, in the present disclosure, the term “unit” does not simply mean physical means but includes a case where the function of the “unit” is implemented by software. Furthermore, the function of one “unit” or device may be implemented by two or more physical means, devices, or pieces of software, or the functions of two or more “units” or devices may be implemented by one physical means, device, or piece of software.

### (Supplementary Note 1)

A document management system comprising at least one processor, wherein
the at least one processor is configured to
collectively acquire a plurality of pieces of target document information belonging to a series of correction processes, and
store the plurality of pieces of target document information in a predetermined storage unit in association with order information indicating an order of the series of correction processes.

### (Supplementary Note 2)

A document management program for causing a processor to execute:
collectively acquiring a plurality of pieces of target document information belonging to a series of correction processes; and
storing the plurality of pieces of target document information in a predetermined storage unit in association with order information indicating an order of the series of correction processes.

### (Supplementary Note 3)

A document management system comprising at least one processor, wherein
the at least one processor is configured to
collectively acquire at least one piece of target document information and related material information regarding material related to the at least one piece of target document information, and
store the at least one piece of target document information and the related material information in a predetermined storage unit in association with each other.

### (Supplementary Note 4)

A document management program for causing a processor to execute:
collectively acquiring at least one piece of target document information and related material information regarding material related to the at least one piece of target document information; and
storing the at least one piece of target document information and the related material information in a predetermined storage unit in association with each other.

(Supplementary Note 5) A document management system comprising at least one processor, wherein
the at least one processor is configured to:
acquire target document information including correction history information regarding a history of correction;
extract at least one piece of candidate document information belonging to a same series of correction processes as the target document information from among a plurality of pieces of target document information stored in a predetermined storage unit, on a basis of at least one piece of old edition document information corresponding to a previous version of the target document information, the old edition document information being generated on a basis of the correction history information and corresponding to a correction process corresponding to the history of correction; and
store the target document information, the at least one piece of candidate document information, and order information indicating an order of the correction processes in a predetermined storage unit in association with one another.

### (Supplementary Note 6)

A document management program for causing a processor to execute:
acquiring target document information including correction history information regarding a history of correction;
extracting at least one piece of candidate document information belonging to a same series of correction processes as the target document information from among a plurality of pieces of target document information stored in a predetermined storage unit, on a basis of at least one piece of old edition document information corresponding to a previous version of the target document information, the old edition document information being generated on a basis of the correction history information and corresponding to a correction process corresponding to the history of correction; and
storing the target document information, the at least one piece of candidate document information, and order information indicating an order of the correction processes in a predetermined storage unit in association with one another.

What is claimed is:

1. A document management method executed by a processor, comprising:
collectively acquiring a plurality of pieces of target document information belonging to a series of correction processes; and
storing the plurality of pieces of target document information in a predetermined storage unit in association with order information indicating an order of the series of correction processes.

2. The document management method according to claim 1, further comprising
outputting display information for displaying, on a user terminal, a screen for associating the plurality of pieces of target document information and the order information, wherein
the storing includes storing the plurality of pieces of target document information in association with the order information on a basis of an operation of a user through the user terminal.

3. The document management method according to claim 1, wherein
the collectively acquiring includes acquiring a folder including the plurality of pieces of target document information and collectively acquiring the plurality of pieces of target document information.

4. The document management method according to claim 1, wherein the order information includes information indicating a status of each of the plurality of pieces of target document information.

5. A document management method executed by a processor, comprising:
collectively acquiring at least one piece of target document information and related material information regarding material related to the at least one piece of target document information; and
storing the at least one piece of target document information and the related material information in a predetermined storage unit in association with each other.

6. The document management method according to claim 5, wherein
the at least one piece of target document information includes a plurality of pieces of target document information belonging to a series of correction processes, and
the storing includes storing the plurality of pieces of target document information, order information indicating an order of the series of correction processes, and the related material information in association with one another.

7. The document management method according to claim 5, further comprising
outputting display information for displaying a screen for associating the at least one piece of target document information and the related material information on a user terminal, wherein
the storing includes storing the at least one piece of target document information and the related material information in association with each other on a basis of an operation of a user through the user terminal.

8. The document management method according to claim 5, wherein
the at least one piece of target document information includes target document information regarding a contract, and
the related material information includes related material information in a file format different from the at least one piece of target document information.

9. A document management method executed by a processor, comprising:
acquiring target document information including correction history information regarding a history of correction;
extracting at least one piece of candidate document information belonging to a same series of correction processes as the target document information from among a plurality of pieces of document information stored in a predetermined storage unit, on a basis of at least one piece of old edition document information corresponding to a previous version of the target document information, the old edition document information being generated on a basis of the correction history information and corresponding to a correction process corresponding to the history of correction; and
storing the target document information, the at least one piece of candidate document information, and order information indicating an order of the correction processes in a predetermined storage unit in association with one another.

10. The document management method according to claim 9, further comprising
outputting display information for displaying a screen for associating the target document information, the at least one piece of candidate document information, and the order information on a user terminal, wherein
the storing includes storing the target document information, the at least one piece of candidate document information, and the order information in association with one another on a basis of an operation of a user through the user terminal.

11. The document management method according to claim 9, wherein the extracting includes extracting the at least one piece of candidate document information further on a basis of similarity to the at least one piece of old edition document information.

12. The document management method according to claim 11, further comprising
outputting display information for displaying a screen for associating the target document information, the at least one piece of candidate document information, and the order information on a user terminal, wherein
the at least one piece of candidate document information includes a plurality of pieces of candidate document information, and
the outputting includes outputting display information for displaying the plurality of pieces of candidate document information in order of the similarity.
